(19) United States
(12) Patent Application Publication
(10) Pub. No.: US 2023/0110818 A1
(43) Pub. Date: Apr. 13, 2023

(54) DEVICE FOR MELTING METALS

(71) Applicant: Technische Universität Bergakademie Freiberg, Friedberg (DE)

(72) Inventors: Gotthard WOLF, Mettmann (DE); Andreas KESSLER, Wilsdruff (DE)

(21) Appl. No.: 17/904,879

(22) PCT Filed: Feb. 24, 2021
(86) PCT No.: PCT/EP2021/054553

§ 371 Date: Aug. 24, 2022

(30) Foreign Application Priority Data
Feb. 26, 2020 (DE) 10 2020 202 484.7

(51) Int. Cl. H05H 1/34; H05H 1/18; C22B 9/22

(52) U.S. Cl. CPC H05H 1/3405; H05H 1/18; C22B 9/226

(57) ABSTRACT

An apparatus for melting metals whose melting temperature is below 1000° C. may have a device for forming a plasma arranged on a melting furnace. The device is connected to an electrical voltage supply and to the device at least one first supply for a plasma gas, with which the plasma can be formed, and is designed, dimensioned, arranged and/or aligned in such a way that the formed plasma is arranged at a distance from the metal as the material to be melted, and in this case a hot gas stream can be formed with the plasma, which hot gas stream is aligned in the direction of the material to be melted, and a melting tank or crucible is arranged in the melting furnace to receive the molten metal.

The invention relates to an apparatus for melting metals, in particular non-ferrous metals. In this context, the term metals should also be understood to include corresponding alloys whose melting temperature should also be less than 1000° C. if possible. The invention is particularly suitable for melting aluminum and its alloys.

It has thus far been common practice to melt these metals in differently configured melting furnaces using oil or gas burners, with the hot flame of which the respective metal can be transferred into the liquid phase. During the combustion of the respective hydrocarbon compound, CO₂ formed by chemical oxidation is released into the earth's atmosphere in relatively large quantities, which is extremely detrimental from a climate change perspective.

Furthermore, it is also known to perform induction heating of metal as a melt material. As a result of the alternating electric fields that occur, however, a strong stirring effect of the melt formed occurs. This leads to oxide inclusions in the metal to a high degree, so that the quality of the components produced with the melt obtained in this way is strongly adversely affected. Induction-heated melting furnaces are also generally poorly suited to melting coarse circulating material or cast iron scrap as a result of unfavorable coupling conditions.

Also known are electrically resistance-heated furnaces. These usually only have a low output and are therefore generally only suitable for keeping already liquid metal warm.

There have also been efforts to use plasma to melt metal. In these cases, an electric arc was used to form plasma. For this purpose, an electrode was contacted with unmelted melt material. However, this leads to contaminations of the respective metal to be melted, which cannot be avoided or specifically influenced. Loss of contact leads to immediate termination of the arc during deposition and must therefore be avoided by very elaborate process control.

It is therefore the object of the invention to provide possibilities for melting metal in which the system complexity can be kept within limits, the release of CO₂ on site as well as contamination of the melt obtained can be avoided to the greatest possible extent.

According to the invention, this object is solved with an apparatus having the features of claim 1. Advantageous embodiments and further developments of the invention can be realized with features designated in dependent claims.

In the apparatus for melting metals according to the invention, in particular non-ferrous metals, whose melting temperature is preferably less than 1000° C., a device for forming a plasma in the form of a free gas torch and heat transfer by radiation to the melt material is arranged on a melting furnace. This may be an otherwise familiar melting furnace having the same configuration. Preferably, shaft furnaces, hearth-type furnaces but also crucible furnaces are suitable.

The device is connected to an electrical voltage supply and, in addition, at least a first supply of a plasma gas with which the plasma is formable is connected.

The device is designed, dimensioned, arranged and/or aligned in such a way that the formed plasma is arranged at a distance from the metallic melt material, and in this case a hot gas stream can be formed with the plasma, which is aligned in the direction of the melting material. The plasma formed thus never comes into direct contact with the unmelted melt material or the melt. This can also avoid the use of an electrode that contacts the melt material or melt, since no such electrode should be present.

The plasma formed should act solely as a heat source. As a result, heating of the metallic melt material can be achieved solely by means of the thermal energy of the hot gas stream and by thermal radiation emitted by the plasma.

For this purpose, the generated plasma should be designed and arranged in the apparatus in such a way that at least almost no free electrically charged particles (in particular ions, electrons) can come into direct contact with the metal to be melted. For this purpose, the volumetric flow rate and the flow velocity of at least one further supplied gas, with which the hot gas stream is essentially formed, can also be set or controlled accordingly.

The plasma can also be mixed with another gas (secondary gas) in such a way that a stable plasma torch or gas torch is formed with the plasma, which also emits radiation energy in the direction of the melt material. The melt material can be used with the hot gas of the plasma torch or gas torch and additionally the radiation energy to transfer heat and melt the molten material in the furnace chamber of the melting furnace.

A melting tank or crucible is arranged in the melting furnace to receive the molten metal.

In an alternative according to the invention, the device can be designed with a microwave generator and resonator connected thereto with at least one reflection plate for generated microwaves, which is formed as a waveguide. In addition, an electrical ignition device with an ignition electrode electrically insulated from a housing should be part of the device. The ignition device is used exclusively for igniting a plasma and can be switched on when a plasma has been formed in a sufficiently large quantity after free charge carriers of the plasma gas used have been formed with generated microwaves.

The plasma should be formed in the region of standing microwaves within the resonator in front of the at least one reflection plate with plasma gas flowing there. Translational motion of the formed plasma can be largely avoided, allowing it to form a stationary heat source for the formation of a hot gas stream.

In this alternative, the plasma should be formed in the housing of the device, with the hot gas stream directed toward the melt material inside the melting furnace via at least one flow guide element. Tubular or channel-shaped elements can be used as flow guide element(s) through which the hot gas can flow in the direction of the melt material. Flow guide elements can be formed from a glass, glass ceramic or pure ceramic material. There may also be at least two flow guide elements. In this case, a flow guide element can be arranged at least in a region inside a flow guide element with a larger inner diameter or larger free cross-sectional area and form a shield against heat there. Flow guide elements should not be in direct contact.

In another alternative, the device may be formed with two electrodes spaced apart from each other, between which a plasma gas flows toward the melt material and an electric arc discharge occurs. The device can be designed analogously to a plasma torch known per se, such as is used for cutting and welding materials. In this case, an electrode is usually formed of tungsten, hafnium or an alloy thereof. The counter-electrode can form a housing through which plasma gas flows. Only the dimensioning and the operating parameters should be adapted to the application for melting metal. But even in this case, the plasma formed should not come into direct contact with the melt material and should serve only as a heat source for heating a gas that can be used as a hot gas stream or a free gas torch for melting.

At least one additional supply for plasma gas or another gas (secondary gas) can be connected to the housing. This further feed can be arranged at a distance from the first feed. Preferably, the further feed can be arranged in the area of the formed plasma or behind it in the direction of flow.

Advantageously, the electrical power of the microwave generator of the device or the electrical arc discharge, the volumetric flow of the plasma gas and/or the volume flow of the further gas can be controlled. For example, a measured temperature can represent the controlled variable. This can be the temperature of the hot gas stream, the plasma, the melt material or the melt. The temperature should preferably be determined in a contactless manner, for example by means of thermography or a pyrometer. However, it is also possible to regulate the temperature. Depending on the process control, this can be done, for example, to melt or keep warm a melt.

It is also possible to regulate the microwave generator in such a way that the length of the gas torch formed with the plasma or the length of the formed plasma torch is adjusted in the direction of the melt material, so that in particular the proportion of usable radiation energy can be influenced.

Advantageously, plasma gas can be allowed to flow tangentially into the housing with a swirl before it comes under the influence of the microwaves. As a result, the contact time can be extended and the free charge carriers (ions, electrons) can be brought to a higher energy level more effectively, so that the efficiency can be increased.

However, another gas can also flow tangentially into the housing alone or in addition. It is possible to introduce plasma gas into the housing parallel to the longitudinal axis of the housing of the device or the direction of flow of the hot gas stream. It can thereby flow into the housing of the device through an inflow opening, which can be arranged directly next to the ignition device.

Inlets for plasma gas can be arranged around the circumference of the housing, through which plasma gas can flow from the feed into the housing.

Advantageously, argon can be used as a plasma gas and/or other gas, since it is completely inert with respect to the melt material and the melt. Nitrogen as a plasma or other gas should be avoided, especially when melting aluminum or its alloys. Oxygen or air promote oxidation and are therefore detrimental in this respect.

However, it is also possible to use a gas mixture as plasma gas or other gas. In this process, the respective gas proportions of the gas mixture can be adapted to the particular metal to be melted. For example, argon can be mixed with air, but the air content should be smaller than the argon content.

There may also be a recirculation system for hot gas withdrawn from the melting furnace, by means of which reuse of this gas as plasma gas and/or further gas in the cycle or other use of the residual heat can be achieved. A closed-loop operation makes it possible to reduce the required amount of plasma gas or other gas to be added, which reduces costs, especially for argon.

However, the residual heat of the extracted hot gas can also be utilized, for example, for keeping the melt obtained warm or for preheating further gas in particular.

In the invention, microwaves with a frequency in the range 500 MHz to 5000 MHz, with an electrical power in the range 5 kW to 3000 kW can be used.

The total volume flow of plasma gas and/or other gas should be selected at least large enough so that the hot gas stream entering the melting furnace reaches the unmelted melt material, or at least comes close to it, so that the melting material is melted as a result of thermal radiation.

It is also advantageous to arrange an ignition electrode of an ignition device for plasma generated by means of microwaves in a radiation trap. For this purpose, this ignition electrode can be arranged in a tubular or channel-shaped element whose inner diameter or inner free cross-sectional area is smaller than that of the housing of the device in which the plasma is formed.

It is particularly advantageous if the tip of this electrode is recessed in the tubular or channel-shaped element, i.e. that this tip is arranged inside the radiation trap. By means of such a design, the service life of this ignition electrode can be increased and contamination of the melt with the material of this electrode can be completely avoided.

The apparatus for forming a plasma can advantageously be attached to the furnace body in a pivotable device, so that targeted and variable guidance of the gas torch, plasma torch or hot gas stream in the furnace chamber is possible. This allows the direction of a gas torch or plasma torch to be changed and locally targeted heating of the respective melt material in the furnace chamber to be achieved. For example, the outer edges or the center of the melt material arranged in the furnace chamber can be heated to a greater or lesser extent as required at any given moment.

In the invention, the housing can be cooled at least in some areas. It may also be advantageous to temper the flow guide element(s) in particular in order to advantageously reduce the effect of strong temperature changes in this area, especially advantageously large temperature differences occurring for a short time should be avoided.

As already explained, the invention can significantly reduce the amount of CO₂ released. Existing melting furnaces can be converted or retrofitted with very little effort. The quality of the molten metal is at least equal to that which can be achieved with conventional gas or oil burners. Contamination and oxidation of the molten metal can be avoided at least to a large extent, if not entirely.

In the following, the invention will be explained in more detail by way of example. Features can be combined with each other regardless of the particular example or the corresponding illustration in a figure. The individual features are not limited to the particular example or illustration.

Shown are:

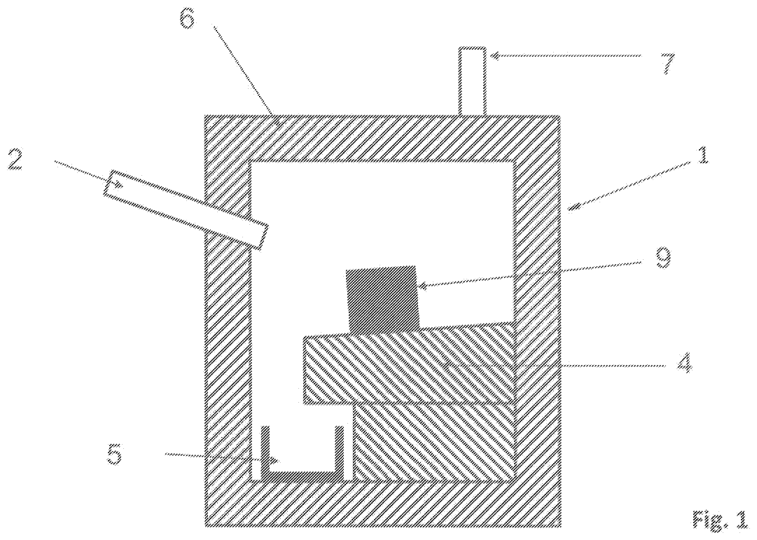

FIG. 1 a schematic representation of an example of an apparatus according to the invention and

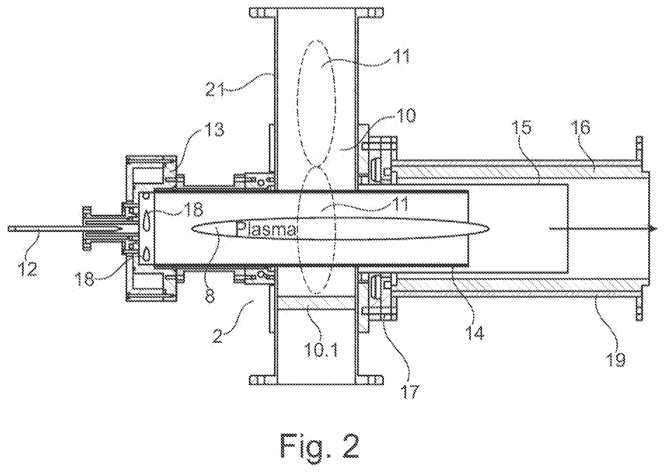

FIG. 2 a sectional view through a portion of an example of a device for forming a plasma using microwaves.

FIG. 1 schematically shows an example of an apparatus according to the invention with a melting furnace 1. On one side of the melting furnace 1 there is a door (not shown) through which it is possible to feed the melting furnace 1 with unmelted melt material 9. The unmelted melt material 9 may be deposited on a melting platform 4 which is inclined at an angle, in the example shown an angle of 10°, so that molten metal can drip off the melting platform 4 into the crucible 5 or a melting tank not shown.

A device 2 for forming a plasma is flanged to the housing 6 of the melting furnace 1, and at least one flow guide element not shown here for a hot gas flow hot gas stream is guided through the housing wall of the melting furnace 1 into the interior of the melting furnace 1, so that at least one hot gas flow can be directed onto the unmelted melt material 9. The housing is pivotally mounted so that this allows the gas, plasma torch or a hot gas stream formed with the plasma 8 to be tracked during melting.

By means of a viewing window recessed in the housing wall 6 of the melting furnace 1, it is possible to observe the melting process from the outside or it is also possible to determine the temperature inside the melting furnace 1 from there.

In FIG. 1, there is also an exhaust 7 for hot exhaust gas on the melting furnace 1, through which hot exhaust gas can be extracted from the melting furnace 1. The hot exhaust gas can be recirculated and recycled, for example as plasma gas or other gas.

Extracted hot exhaust gas may also be used to keep molten metal warm or for some other use where one can utilize the heat energy.

Hot exhaust gas can also be passed through a heat exchanger.

FIG. 2 shows essential elements of a device 2 for forming a plasma. A microwave generator, which may be a commercially available product, has not been shown. It is flanged to the resonator 10.

The microwaves 11 generated by the microwave generator can be obtained as standing waves in the resonator 10. For this purpose, a reflection plate 10.1 is also arranged in a flange of the housing 13 of the device 2 opposite a second flange 21. The microwave generator is connected to the second flange 21.

The reflection plate 10.1 may be formed of a glass. In the vicinity of the reflection plate 10.1 for microwaves, a feed 17 for a cooling gas is provided in the housing 13 of the device 2. In addition to its cooling effect, cooling gas can also flow along the surface of the reflection plate 10.1 inside the housing 13 and clean it or keep it free of particles.

In FIG. 2, an ignition device with a rod-shaped ignition electrode 12 can be seen on the left of the housing 13 of the device 2. The ignition electrode is connected to one pole of an electrical voltage source not shown. If an electrical voltage is applied to this ignition electrode 12 for a short time, an additional increase in the energy of supplied plasma gas can be achieved, which leads to the ignition of a plasma 8 in the area of the resonator 10 and standing microwaves 11 formed there. After the plasma 8 has been ignited, the ignition device can be switched off.

The housing 13 can be designed in the area of the ignition device with the ignition electrode 12 as a radiation trap, as explained in the general part of the description.

Plasma gas may enter solely through the radiation trap or solely through inlets 18 distributed around the circumference of the housing 13. However, a combination of these is also possible.

A swirl effect can be achieved and exploited by a tangential inflow through preferably several inlets 18.

In the example shown, a further feed for another gas has been omitted. However, at least one additional gas can be introduced into the housing 13 of the device 2, preferably in the area of the formed plasma gas 8. Further gas can then be used at least predominantly for the hot gas stream.

The hot gas stream leaves the device 2 in the direction of the arrow shown. For this purpose, three tubular flow guide elements 14, 15 and 16 are present in this example. The quartz glass tube 14 with the smallest diameter encloses the formed plasma 8. It is enclosed in its region facing in the direction of the melting furnace 1, which is arranged opposite the ignition device, by a further tubular flow guide element 15, which can simultaneously form a shield against thermal radiation.

In the area of the flange of the housing 13, which is arranged facing in the direction of the melting furnace 1, a third tubular flow guide element 16, the diameter of which is the largest, is arranged. The third flow guide element 16 may be guided at least as far as the wall of the housing 6 of the melting furnace 1, so that the hot gas stream can be directed through an opening in the wall of the housing 6 onto the melt material 9 arranged in the melting furnace 1. However, its length can also be selected so that it extends into the interior of the melting furnace 1.

The third tubular flow guide element 16 may be guided and retained in a flange 19 of the housing 13 of the device 2. The flow guide elements 14, 15 and 16 are inserted into each other. However, they should not contact one another.

In addition to the supply 17 for a cooling gas, other areas of the housing 13 of the device 2 can be designed and used for cooling. For this purpose, a cooling medium (gas or liquid) can flow through these areas. These areas should be arranged at least in the vicinity of the formed plasma 8.

In the example shown, flanged cooling 20 is provided in a portion of the housing 13 of the device 2.

What is claimed is

1-16. (canceled)

17. An apparatus for melting non-ferrous metals, comprising: a device for forming a plasma is arranged on a melting furnace, the device being connected to an electrical voltage supply and at least one first feed for a plasma gas, with which the plasma can be formed, being connected to the device, and
the device being designed, dimensioned, arranged and/or aligned in such a way that the plasma formed is arranged at a distance from the metal as the material to be melted, and in this case a hot gas stream can be formed with the plasma, which hot gas stream is aligned in the direction of the material to be melted, and a melting tank or crucible is arranged in the melting furnace to receive the molten metal.

18. The apparatus according to claim 17, wherein the device is designed in such a way that plasma gas of the plasma and further gas form a free gas torch or plasma torch in the furnace chamber of the melting furnace which can use its hot gases and radiation energy for heat transfer and melting of a respective metal.

19. The apparatus according to claim 17, wherein the device is provided with a microwave generator and resonator connected thereto, which is designed as a waveguide and has at least one reflection plate for generated microwaves.

20. The apparatus according to claim 19, wherein the device is formed with an electrical ignition device, with an ignition electrode electrically insulated from a housing, the plasma being formed in the region of standing microwaves inside the resonator in front of the at least one reflection plate with plasma gas flowing there, and the plasma being formed in the housing.

21. The apparatus according to claim 20, wherein the hot gas flow is directed in the direction of the melt material via at least one flow guide element.

22. The apparatus according to claim 20, wherein the ignition electrode of the electric ignition device for plasma is arranged in a radiation trap.

23. The apparatus according to claim 17, wherein the power, the length, the temperature and/or the length of a free gas flare or a plasma flare can be varied with a controllable microwave generator.

24. The apparatus according to claim 17, wherein the device is formed with two electrodes which are arranged at a distance from one another and between which a plasma gas flows in the direction of the material to be melted and an electric arc discharge takes place.

25. The apparatus according to claim 17, wherein more than one supply for plasma gas or a more than one gas is connected to the housing of the device.

26. The apparatus according to claim 19, wherein electrical power of the microwave generator or an electrical arc discharge of the device, a volumetric flow of the plasma gas and/or a volumetric flow of the further gas can be controlled.

27. The apparatus according to claim 17, wherein at least the plasma gas and/or a further gas flows tangentially into the housing with a swirl.

28. The apparatus according to claim 27, wherein argon is used as the plasma gas and/or further gas.

29. The apparatus according to claim 19, wherein microwaves having a frequency in the range 500 MHz to 5000 MHz, at an electrical power in the range 5 kW to 3000 kW are used.

30. The apparatus according to claim 17, wherein a gas mixture is used as plasma gas and/or a further gas.

31. The apparatus according claim 17, wherein a recirculation system for hot gas withdrawn from the melting furnace is provided, by which a renewed use of this gas as plasma gas and/or further gas in the cycle or another use of the residual heat is achievable.

32. The apparatus according to claim 17, wherein the device is fixed to the furnace body in a pivotable device, so that a targeted and variable guidance of a gas flare, a plasma flare or a hot gas flow in the furnace chamber is made possible.
